(19) United States
(12) Patent Application Publication
(10) Pub. No.: US 2021/0029780 A1
(43) Pub. Date: Jan. 28, 2021

(54) MOBILE GATEWAY FOR VEHICLES AND EQUIPMENT

(71) Applicants: Daniel George Vernon, Ashland, WI (US); Brian Carl Gustafson, Roosevelt, MN (US); Matthew Todd Freudenrich, Fort Ripley, MN (US)

(72) Inventors: Daniel George Vernon, Ashland, WI (US); Brian Carl Gustafson, Roosevelt, MN (US); Matthew Todd Freudenrich, Fort Ripley, MN (US)

(73) Assignee: Northern Clearing, Inc., Ashland, WI (US)

(21) Appl. No.: 16/938,732

(22) Filed: Jul. 24, 2020

Related U.S. Application Data
(60) Provisional application No. 62/879,286, filed on Jul. 26, 2019.

(51) Int. Cl. H04W 88/16; H04W 4/029; H04W 40/24

(52) U.S. Cl. CPC H04W 88/16; H04W 40/244; H04W 4/029

(57) ABSTRACT

A mobile gateway device that includes a receiver configured to electronically receiving wirelessly-transmitted data from a beacon connected to a vehicle or piece of equipment being tracked or monitored, where the wirelessly-transmitted data relates to a status or location of the vehicle or piece of equipment. A transmitter is configured to wirelessly transmit the data received from the beacon to a smart device or to a cloud-based computer server. The mobile gateway device includes a processor and electronic memory. The processor is configured to control operation of the receiver and the transmitter. The electronic memory is configured to store the wirelessly-transmitted data. A housing houses the receiver, transmitter, processor and electronic memory.

### FIELD OF THE INVENTION

This invention generally relates to a mobile gateway device for tracking and monitoring a vehicle or piece of equipment.

### BACKGROUND OF THE INVENTION

With asset tracking becoming an integral part of many businesses, there is a need in the marketplace to provide a cost-effective solution for companies and individuals to track assets, materials, and tools with lower cost values where it does not make economic sense to track those materials with higher cost methods such as dedicated cellular enabled trackers. For example, there is a need for such asset tracking with respect to vehicles and equipment used on commercial and industrial construction sites which may have large and spread out footprints.

Embodiments of the invention described herein provide such a device and method which addresses the aforementioned problems with asset tracking. These and other advantages of the invention, as well as additional inventive features, will be apparent from the description of the invention provided herein.

### BRIEF SUMMARY OF THE INVENTION

In various embodiments, the mobile gateway device will be both cellular-enabled and Wi-Fi-enabled, sending gathered data to a cloud-based server for the end user to manage both beacon data and vehicle/equipment GPS data. The mobile gateway device may also be designed to function while disconnected from both cellular and Wi-Fi. If the vehicle or piece of equipment and associated beacon, or if the mobile gateway device, is in an area of insufficient cellular coverage or does not have a Wi-Fi network available, the data from the beacon will be saved internally until a cellular or Wi-Fi connection is established thus allowing the saved data to be transferred to the cloud.

In one aspect, embodiments of the invention provide a mobile gateway device that includes a receiver configured to electronically receiving wirelessly-transmitted data from a beacon connected to a vehicle, piece of equipment, materials, or any other asset being tracked or monitored, where the wirelessly-transmitted data relates to a status or location of the vehicle or piece of equipment. A transmitter is configured to wirelessly transmit the data received from the beacon to a smart device or to a cloud-based computer server. The mobile gateway device includes a processor and electronic memory. The processor is configured to control operation of the receiver and the transmitter. The electronic memory is configured to store the wirelessly-transmitted data. A housing houses the receiver, transmitter, processor and electronic memory.

In a particular embodiment, the receiver is configured to receive the wirelessly-transmitted data which is data being transmitted using one of a Bluetooth protocol, cellular protocol, RFID protocol, Zigbee protocol, LoRaWAN protocol, and GPS-based protocol. In a further embodiment, the transmitter is configured to wirelessly transmit the data received from the beacon using one of a Bluetooth protocol, a cellular protocol, and a GPS-based protocol.

In certain embodiments, the housing is waterproof, impact resistant, and vibration resistant. The processor may be configured to recognize a unique identifier for the beacon from which the wirelessly-transmitted data is received. The electronic memory may be configured to store at least 5,000 of the unique identifiers. Additionally, the processor may be configured to store, in the electronic memory, a data log with the wirelessly-transmitted data from one or more beacons. Each entry in the data log includes a unique identifier for the respective beacon, a beacon location, movement data, a time stamp, temperature, and other environmental information.

In some embodiments, after data from one of the one or more beacons is stored in the data log, a threshold amount of time must pass before the processor will store additional data from the same beacon in the data log. In a further embodiment, the threshold amount of time is at least 15 seconds. Each entry in the data log may further include a location of the mobile gateway at the time wirelessly-transmitted data was received, and information on movement of the beacon.

In a particular embodiment, the processor is configured to establish a cellular or Wi-Fi network connection. In a further embodiment, after receiving the wirelessly-transmitted data from the beacon, the processor automatically determines whether a cellular or Wi-Fi network connection has been established. The processor may be automatically programmed to cause the transmitter to transmit the wirelessly-transmitted data to a cloud server when the cellular or Wi-Fi network connection has been established.

In certain embodiments, wherein the housing includes an open portion and an end cap that seals against the open portion, wherein a circuit board, that includes the processor, electronic memory, receiver, and transmitter, is attached to the end cap such that the circuit board is disposed within the open portion when the end cap is assembled to the open portion. Further, the housing may include one or more LED light portals that provide a status indicator for the mobile gateway device. Further still, the one or more LED light portals may be color coded where different colored lights are used to indicate different operating modes of the mobile gateway device.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective drawing illustrating how a mobile gateway device wirelessly communicates with beacons, in accordance with an embodiment of the invention;

FIG. 2 is a schematic diagram illustrating an exemplary system that incorporates the mobile gateway device, in accordance with an embodiment of the invention;

FIG. 3 is a block diagram of the mobile gateway device according to an embodiment of the invention;

FIG. 4 is a perspective view of the mobile gateway device illustrating a circuit board and housing, in accordance with an embodiment of the invention;

FIG. 5 is a flowchart illustrating the operation of a beacon as it might be used with the mobile gateway device, according to an embodiment of the invention; and

FIG. 6 is a flowchart illustrating the operation of the mobile gateway device, according to an embodiment of the invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

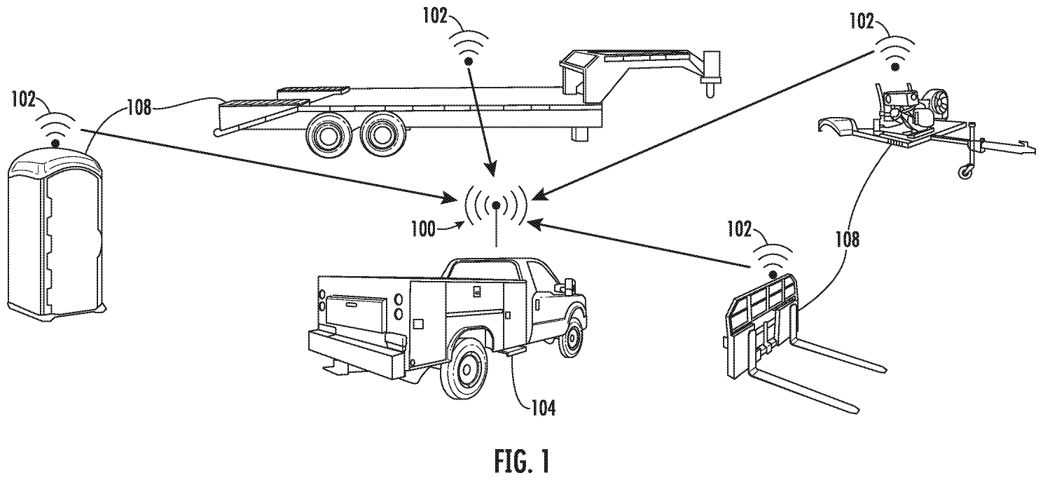

FIG. 1 is a perspective drawing illustrating how a mobile gateway device 100 wirelessly communicates with various beacons 102, in accordance with an embodiment of the invention. In a particular embodiment of the invention, an all-weather mobile gateway device 100 is installed on a vehicle 104 or some piece of equipment 104 which may be mobile or stationary, depending on the specific usage. In a typical application, the mobile gateway device 100 is wired directly into the vehicle/equipment 104. Particular embodiments of the mobile gateway device 100 are GPS-enabled, as well as Bluetooth-enabled and cellular-enabled. The mobile gateway device 100 is configured to communicate with the beacon, which is installed or attached to the asset or equipment 108 being tracked.

The mobile gateway device 100 may be configured to allow the user to perform the following vehicle tracking services, which include, but are not limited to: 1) tracking the asset or equipment 108; 2) monitoring the current speed versus the posted speed limit and alerting the user based on user-established speed thresholds; 3) recording of excessive braking and accelerating, and notifying the user based on user-established thresholds; 4) recording when the operator of the vehicle 104 has failed to stop at a posted stop sign or street signal; 5) recording the maintenance performed on the asset or equipment 108 and next dates on which maintenance is due; 6) documenting operator inspections based on user established content and frequency; and 7) monitoring and recording of perimeter walk around inspections.

As referenced above, the mobile gateway device 100 may be configured with a built-in Bluetooth receiver utilized to capture Bluetooth beacon data as the vehicle or piece of equipment comes within range of one of the beacons. This allows users to place a beacon 102 on the asset or equipment 108 that will be tracked, and, for example, as the vehicle or piece of equipment 104 with the installed mobile gateway device 100 traverses the work area, the mobile gateway device 100 will gather the necessary data from any nearby assets or equipment 108 that have installed beacons 102.

In certain embodiments of the invention, in addition to tracking features outlined above, the mobile gateway device 100 includes the ability to track the following information with respect to the piece of equipment being tracked: 1) tracking and recording movement of the vehicle/equipment 104 via an accelerometer in the beacon; 2) tracking and recording temperature of the vehicle/equipment 104; 3) tracking and recording the moisture levels in and around the vehicle/equipment 104; 4) tracking and recording the time the vehicle/equipment 104 was last connected and moved; and 5) sounding an audible alarm when commanded.

As provided herein, it is possible to use the mobile gateway devices 100 and beacons 102 disclosed herein for many different purposes, ranging from business marketing to asset tracking. In some applications, these mobile gateway devices 100 are stationary and used to track the Bluetooth-enabled beacons 102 as they pass by. Embodiments of the present invention will allow users to install the above-described mobile gateway devices 100 on vehicles and/or equipment 104 and use them to receive data from Bluetooth-enabled beacons 102 that are placed on any asset or equipment 108 the user chooses to track.

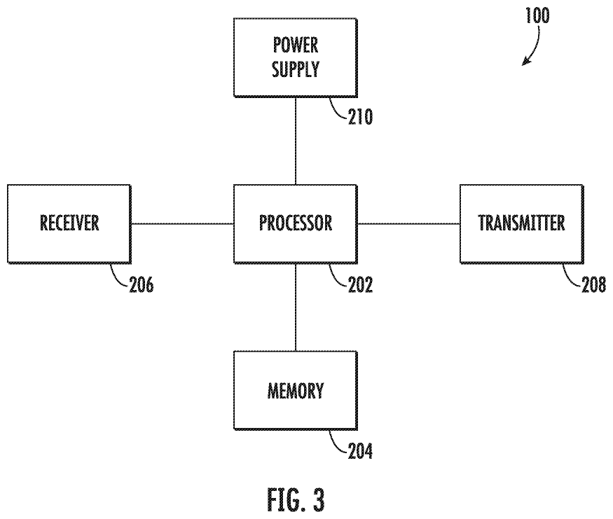

In a more particular embodiment, once there is power being supplied to the mobile gateway device 100, one or more LED light portals on the mobile gateway device 100 light up (see FIG. 3). In further embodiments, the one or more LED light portals are capable of lighting up using different colors. For example, different color combinations of the LED light portals may indicate different operating modes of the mobile gateway device 100, or may indicate the current status of the device 100. Additionally, the mobile gateway device 100 may be configured to acquire cellular or internet/network connectivity immediately upon startup.

Table 1, shown below, provides an exemplary scheme for how multiple LED light portals could be used to give the user a visual indicator for the status of the mobile gateway device 100. In the scheme shown, a steady green light indicates that the mobile gateway device 100 is functioning properly, while various series of blinking blue, red, and violet lights indicates the state of connectivity and associated data transfer for the mobile gateway device 100.

TABLE 1

| LED Color | Gateway Status |
|---|---|
| Green | OK |
| Blue One Blink | Communication via Wi-Fi |
| Blue Two Blinks | Communication via Cellular |
| Red One Blink | No Communication |
| Red Two Blinks | No GPS Signal - No Data Logging occurring |
| Violet Blink | App is connected to the Gateway |

In certain embodiments, the use of relatively low-cost Bluetooth low-energy beacons is combined with various currently-used methods of GPS tracking of a vehicle or piece of equipment in order to provide the user with enhanced and unique capabilities for monitoring the location and status of user assets. The mobile gateway device 100 may be designed to withstand extreme high and low temperatures, and may be waterproof, as well as able to withstand excessive vibration and impact.

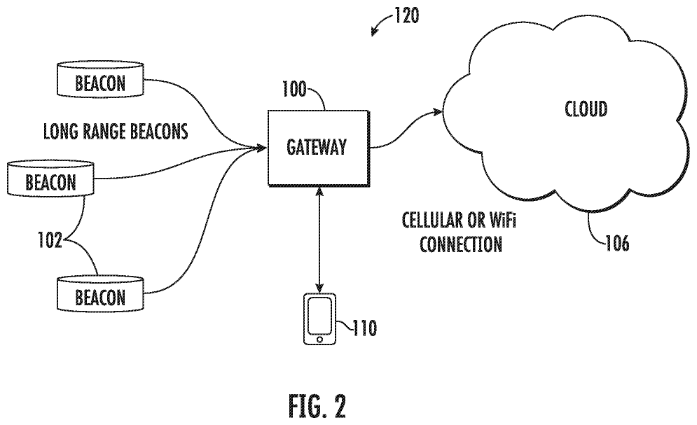

In a further embodiment, the mobile gateway device 100 is cellular-enabled, and configured to send gathered data to a cloud-based server for the end user to manage both beacon data and vehicle or equipment GPS data. FIG. 2 is a schematic diagram illustrating an exemplary system 120 that incorporates the mobile gateway device 100, in accordance with an embodiment of the invention. If the asset or equipment 108 (see FIG. 1) being tracked, or the mobile gateway device 100, is in an area of insufficient cellular coverage, the tracking data will be saved in the mobile gateway device 100 until a cellular connection is established allowing the data to be transferred to the cloud 106.

With respect to the disclosed invention, it is envisioned that the typical price point of a Bluetooth-enabled beacon will be substantially cheaper than that for the typical GPS unit in use today. Furthermore, there is no recurring monthly fee for a cellular plan to send information to the cloud 106. Consequently, this lower-cost solution, embodied by the present invention, will provide users with the ability to track and monitor items that they have never been able to track or monitor due to the excessive cost associated with conventional tracking systems.

If the user deploys the asset or equipment 108 in an area of known poor cellular coverage, embodiments of the invention are configured to work with a mobile application on a smart device 110, e.g., such as a smart phone, tablet computer, notebook computer, etc., which is provided to allow the user to pair with the mobile gateway device 100 on the vehicle or piece of equipment 104 and receive the data that the mobile gateway device 100 has stored internally. The smart device 110 will later send the gathered information to the cloud 106 when the smart device 110 is either connected to an internet source or in an area of adequate cellular service.

The aforementioned mobile application may also be used to access various features of the mobile gateway devices 100 and in order to perform certain tasks including, but not limited to: 1) setting up the Wi-Fi Network; 2) setting or assigning operating modes/features for the mobile gateway device 100; 3) troubleshooting; and 4) activating or deactivating cellular connectivity.

As previously mentioned, the beacon and mobile gateway data can be sent to the cloud 106. From there, the user is able to access this information either via a web interface or a mobile application on the aforementioned smart device 110. In particular embodiments of the web interface or mobile application, the user is able to see where their asset or equipment 108 is located on a map. This map may include standard aerial and road map imagery as well as satellite imagery with an overlay showing the asset or equipment 108 being tracked, and an overlay which also shows the user's construction project layout (i.e. roads, structures, right-of-way, etc.) for reference.

It is envisioned that the user may obtain detailed information for a specific asset or piece of equipment 108 by manually tapping on the icon or clicking on the icon using a cursor. As the user selects a particular asset or piece of equipment 108 on a computer or smart mobile device 110, the user will access the data (for example, but not limited to, the time of last connection, temperature data over time, beacon battery status, last recorded movement, etc.) collected by the mobile gateway device 100 from the beacon 102 for that asset or piece of equipment 108.

FIG. 3 is a block diagram of the mobile gateway device 100 according to an embodiment of the invention. The mobile gateway device 100 includes a processor 202 with electronic memory 204. The processor 202 is coupled to a receiver 206 and a transmitter 208. A power supply 210 provides power to the processor 202, electronic memory 204, receiver 206, and transmitter 208. The power supply 210 may be within the mobile gateway device 100 or may be provided externally from the vehicle or piece of equipment on which the mobile gateway device 100 is installed.

The processor 202 is configured to control operation of the receiver 206 and the transmitter 208, while the electronic memory 204 is configured to store the wirelessly-transmitted data captured by the receiver 206. The receiver is configured to receive wirelessly-transmitted data from the beacon 102 connected to the vehicle or piece of equipment 108 being tracked or monitored. Generally, the wirelessly-transmitted data includes a status, a unique beacon identifier, and location of the beacon 102. In this case, the status may include, but is not limited to, the remaining battery life for the beacon 102, suggested or required maintenance for the beacon, operability of any sensors, accelerometers, etc.

The wirelessly-transmitted data may also include a time stamp, information related to movement of the beacon 102, environmental data such as temperature, pressure, moisture level, etc. The transmitter 208 is configured to wirelessly transmit the data received from the beacon 102 to a smart device 110 (see FIG. 2) or to a cloud-based computer server. The receiver 206 may be configured to receive the wirelessly-transmitted data when that data is being transmitted using any one of a Bluetooth protocol, cellular protocol, or GPS-based protocol. Similarly, the transmitter 208 may be configured to wirelessly transmit the data from the mobile gateway device 100 using any one of the Bluetooth protocol, cellular protocol, or GPS-based protocol.

In particular embodiments of the invention, the processor 202 includes a RAM table with a data log. The processor 202 populates the data log with the aforementioned wirelessly-transmitted data from the various beacons 202 that come into communication with the mobile gateway device 100. Thus, the data log will typically include the status, a unique beacon identifier, and location of the beacon 102 mentioned above, as well as the time stamp, information related to movement of the beacon 102, and environmental data.

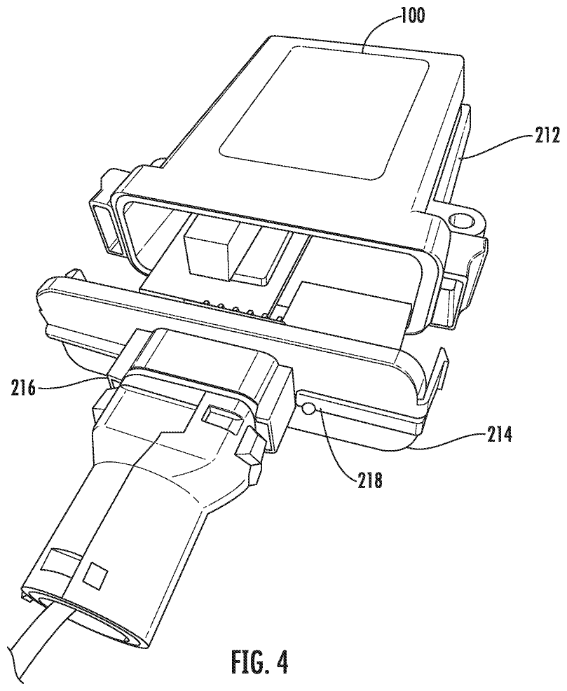

FIG. 4 is a perspective view of the mobile gateway device 100 illustrating a circuit board that includes the processor 202, electronic memory 204, receiver 206, and transmitter 208. FIG. 4 also shows an exemplary housing 212 that houses and protects the aforementioned components of the mobile gateway device 100. In the embodiment of FIG. 4, the circuit board is attached to an end cap 214 of the housing 212.

In a particular embodiment, the circuit board slides fully into the open portion of the housing 212 and the end cap 214 is attached to the open portion of the housing 212 to create a watertight seal. In some embodiments, the end cap 214 is attached to create a hermetic seal with the open portion of the housing 212. In other embodiments, the housing 212 is not only waterproof, but also impact resistant and vibration resistant. The embodiment of FIG. 4 also shows a connector 216 attached to the end cap 214. External power to the mobile gateway device 100 can be supplied via connector 216.

In an exemplary installation, the mobile gateway device 100 is mounted on top of the cab of the vehicle or piece of equipment 104 in a location with the fewest number of obstructions between the mobile gateway device 100 and the vehicle/equipment 104 being tracked. In a specific embodiment, the rear of the mobile gateway device 100, which may constitute the aforementioned end cap 214 includes the connector 216 with a wiring plug, should be positioned such that the end cap 214 and connector 216 face the rear of the vehicle or piece of equipment 104. If installing on excavators or other machines that encounter harsh terrain with the potential of damaging the device 100, the mobile gateway device 100 could be mounted in a location that provides the device 100 some physical protection.

For example, the use of adhesive Velcro strips, adhesive strips, magnet, mechanical fasteners, and zip-ties is contemplated. In a specific example, the user attaches one side of a Velcro strip to the bottom of the mobile gateway device housing 212 to ensure the Velcro adheres well to the device 100. Then the user removes the backing on the other side of the Velcro strip, and places the mobile gateway device 100 onto the area of the vehicle chosen for installation. As implied above, when installing the mobile gateway device 100, it is advantageous if the wiring terminal on the connector 216 for the device 100 is facing the rear of the vehicle or piece of equipment 104 on which it is being installed. The mobile gateway device 100 is thus secured by the Velcro strip to the cab of the vehicle or piece of equipment 104.

The housing 212 of FIG. 4 also includes one or more LED light portals 218 for providing indication of an operating mode of the mobile gateway device 100. As explained above, in further embodiments, the one or more LED light portals 218 are capable of lighting up using different colors. For example, different color combinations of the LED light portals 218 may indicate different operating modes of the mobile gateway device 100, or may indicate the current status of the device 100.

In a particular embodiment, the mobile gateway device 100 is wired to a fuse panel on the vehicle or piece of equipment 104 with a 5-ampere fuse in place. However, if the mobile gateway device 100 is wired directly to the vehicle/equipment battery, a 5-ampere inline fuse may be installed within 12 inches of the battery connection.

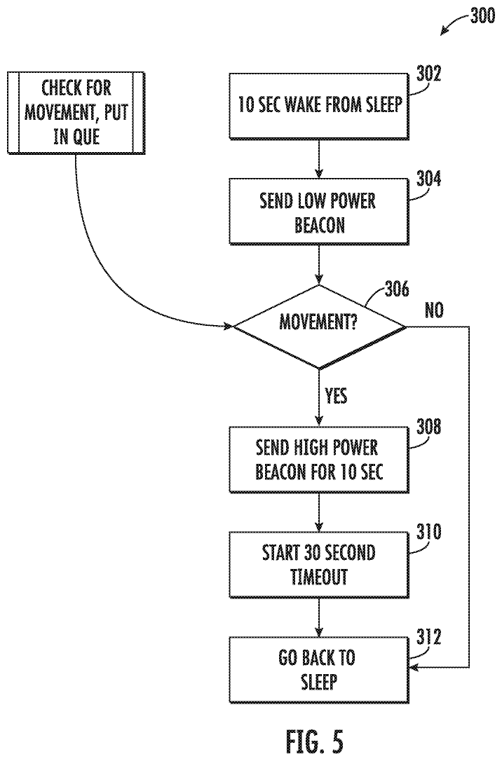

FIG. 5 is a flowchart showing an exemplary process 300 for operation of the beacon 102 (see FIGS. 1-2), in accordance with an embodiment of the invention. As can be seen from FIG. 5, the beacon 102 periodically wakes 302 to transmit data relevant to the asset or equipment 108 on which the beacon 102 is installed. In the example of FIG. 5, the data is transmitted every 10 seconds, however it is understood that the periodic transmission could occur more or less frequently than every 10 seconds. It is also understood that, in particular embodiments, the beacon 102 could be configured to automatically change the period of transmission based on external factors. Typically, these periodic transmissions are low-power transmissions 304 to conserve battery life in the beacon 102. The beacon 102 then determines if the asset or equipment 108 is in motion 306. Typically, this is determined via an accelerometer module located in the beacon 102.

If no movement is detected, the beacon 102 powers down into sleep mode 312. If movement is detected, the beacon 102 sends a high-power transmission 308, at least relative to the low-power transmission of step 304. This high-power transmission 308 includes data from the accelerometer regarding the detected movement, and lasts for a predetermined time period. In the embodiment of FIG. 5, the high-power transmission 308 lasts for 10 seconds, however it is understood that the period of transmission could be greater or lesser than 10 seconds. Following, the high-power transmission 308, the beacon 102 may be programmed to start a timeout period 310. This timeout period may be 30 seconds, as shown in FIG. 5, or substantially longer or shorter than 30 seconds, according to the needs of the user. Following the timeout period 310, the beacon 102 typically goes into sleep mode 312 in advance of the next periodic wake up 302.

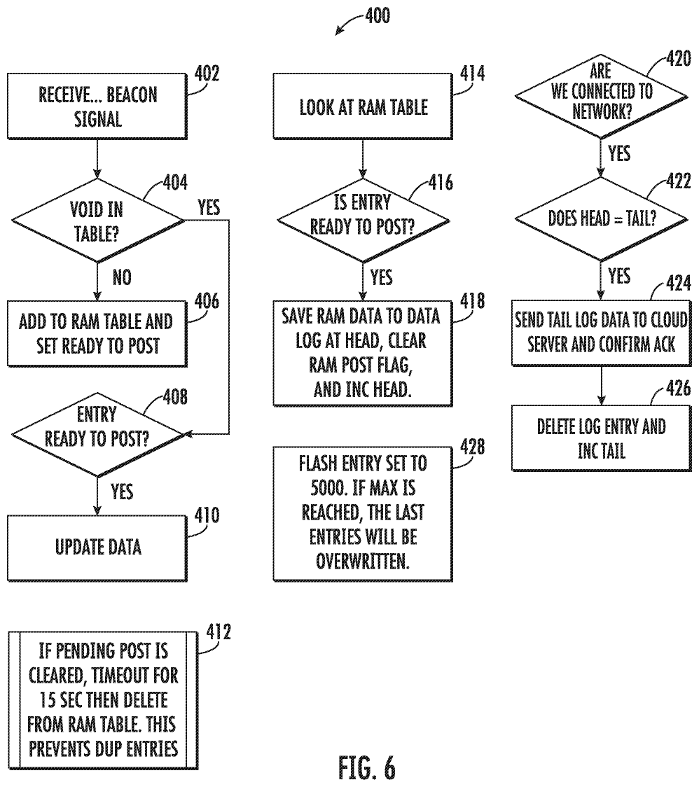

FIG. 6 is a flowchart illustrating an exemplary process 400 for operation of the mobile gateway device 100 (see FIGS. 1-2), according to an embodiment of the invention. When the mobile gateway device 100 receives a wireless transmission 402 from one of the deployed beacons 102 (see FIGS. 1-2), the mobile gateway device 100 checks for beacon's UUID (beacon ID number) in a RAM table 404 in the electronic memory of the mobile gateway device 100. If the beacon's UUID is not found in the RAM table, the beacon UUID is then added to the RAM table 406, and the data from the wireless transmission is made ready to post (i.e., upload to the cloud server). If the beacon UUID is found in the RAM table, the beacon data is already pending posting to the cloud server 408 if a network connection has been established. The beacon data with the location and timestamp for the beacon 102 is updated in the RAM table 410 and is posted to the cloud server.

The mobile gateway device 100 determines if more than a threshold period of time has passed 412 since the last data posting from the same beacon 102. If the threshold period of time since the last data posting from the beacon 102 (see FIG. 3) has not been reached, the mobile gateway device 100 will not accept another data transmission from that beacon 102, though it will receive transmissions from other beacons 102. If the threshold period of time since the last data posting from the beacon 102 has been reached, the beacon data with the, unique identifier, location, and timestamp for the beacon 102 is updated in the RAM table via processor 202, and the data is posted to the cloud server when a network connection has been established. The processor 202 then deletes the beacon data from the RAM table to prevent duplicate entries. In the embodiment of FIG. 6, the threshold period of time is 15 seconds, but in other embodiments could be shorter or longer than 15 seconds.

Steps 414-418 provide an exemplary illustration for how memory is allocated by the processor 202. In steps 414 and 416, the processor looks at the resulting entry in the RAM table from a beacon signal is received by the receiver 206. The processor 202 then checks to determine if the RAM table entry is ready to post (i.e., upload to the cloud server). If the entry is ready to post, the processor 202 saves the RAM table entry at the head of a data log 418. A RAM post flag is cleared and the data log head is incremented 418 to make ready for the next entry.

In certain embodiments, the processor 202 periodically checks for a network connection 420. If there is no network connection, the received data, including location data for the mobile gateway device 100, can be stored internally in electronic memory 204 until a network connection is established. Once the mobile gateway 100 establishes a network connection, the relevant data log entries are sent to the cloud 106 and the data log entries are deleted.

As mentioned above, the network connection can be to a cellular network or Wi-Fi network. The processor 202 then checks the data log to confirm that the head entry is the same as the tail entry 422. This is to confirm that there has been no change to the data as it is readied for posting to the cloud server. If the head entry is the same as the tail entry, the tail entry data is uploaded to the cloud server 424. The processor 202 then waits for a confirmation from the cloud server acknowledging that the data was received 424. When confirmation is received, the processor 202 then deletes the tail entry data and increments the data log tail 426 to make ready for the next entry.

In a specific embodiment, the limit for the number of data log entries is set at 5,000 428. If the maximum amount of flash entries is reached, the oldest entries will be overwritten. However, it is envisioned that alternate embodiments of the invention may include electronic memory 204 that allows for numbers of data log entries substantially greater or lesser than 5,000. Thus, the maximum number of allowable entries can be increased or decreased as necessary based on the demands of the user.

The mobile gateway device 100 sends the tail log data to the cloud server and waits for an acknowledgement from the cloud server confirming receipt of the tail log data. When confirmation is received, the mobile gateway device 100 deletes the tail log data sent to the cloud server. The mobile gateway device 100 then increments the tail after deleting the previous entry.

To summarize, in various embodiments, the mobile gateway device will be both cellular-enabled and Wi-Fi-enabled, sending gathered data to a cloud-based server for the end user to manage both beacon data and vehicle/equipment GPS data. The mobile gateway device 100 is also designed to function while disconnected from both cellular and Wi-Fi. If the vehicle or piece of equipment 104 and associated beacon 102, or if the mobile gateway device 100, is in an area of insufficient cellular coverage or does not have a Wi-Fi network available, the data will be saved internally until a cellular or Wi-Fi connection is established thus allowing the saved data to be transferred to the cloud 106.

In a particular embodiment, when the mobile gateway device 100 is powered on but not connected to the network (cellular or Wi-Fi), it will store location data for itself as well as a time stamp and any beacon data it receives. That data is updated in a log internally and stored until a cellular connection or Wi-Fi connection is established. If the same UUID (beacon ID number) is received multiple times, each time the mobile gateway device 100 recognizes the UUID, it checks the RAM table for that particular UUID. If that UUID exists already in the RAM table, the location and timestamp for that beacon 102 is updated. If the UUID does not exist in the RAM table the processor 202 adds the UUID to the RAM table along with the location data and time stamp, and then prepares the data for uploading to the cloud 106.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A mobile gateway device comprising:
a receiver configured to electronically receiving wirelessly-transmitted data from a beacon connected to a vehicle or piece of equipment being tracked or monitored, the wirelessly-transmitted data relating to a status or location of the vehicle or piece of equipment;
a transmitter is configured to wirelessly transmit the data received from the beacon to a smart device or to a cloud-based computer server;
a processor and electronic memory, the processor configured to control operation of the receiver and the transmitter, the electronic memory configured to store the wirelessly-transmitted data; and
a housing which houses the receiver, transmitter, processor and electronic memory.

2. The mobile gateway device of claim 1, wherein the receiver is configured to receive the wirelessly-transmitted data which is data being transmitted using one of a Bluetooth protocol, a cellular protocol, and a GPS-based protocol.

3. The mobile gateway device of claim 1, wherein the transmitter is configured to wirelessly transmit the data received from the beacon using one of a Bluetooth protocol, a cellular protocol, and a GPS-based protocol.

4. The mobile gateway device of claim 1, wherein the housing is waterproof, impact resistant, and vibration resistant.

5. The mobile gateway device of claim 1, wherein the processor is configured to recognize a unique identifier for the beacon from which the wirelessly-transmitted data is received.

6. The mobile gateway device of claim 1, wherein the electronic memory is configured to store at least 5,000 of the unique identifiers

7. The mobile gateway device of claim 1, wherein the processor is configured to store, in the electronic memory, a data log with the wirelessly-transmitted data from one or more beacons, each entry in the data log including a unique identifier for the respective beacon, a beacon location, and a time stamp.

8. The mobile gateway device of claim 7, wherein, after data from one of the one or more beacons is stored in the data log, a threshold amount of time must pass before the processor will store additional data from the same beacon in the data log.

9. The mobile gateway device of claim 8, wherein the threshold amount of time is at least 15 seconds.

10. The mobile gateway device of claim 7, wherein each entry in the data log further includes a location of the mobile gateway at the time wirelessly-transmitted data was received, and information on movement of the beacon.

11. The mobile gateway device of claim 1, wherein the processor is configured to establish a cellular or Wi-Fi network connection.

12. The mobile gateway device of claim 11, wherein, after receiving the wirelessly-transmitted data from the beacon, the processor automatically determines whether a cellular or Wi-Fi network connection has been established.

13. The mobile gateway device of claim 12, the processor automatically causes the transmitter to transmit the wirelessly-transmitted data to a cloud server when the cellular or Wi-Fi network connection has been established.

14. The mobile gateway device of claim 1, wherein the housing includes an open portion and an end cap that seals against the open portion, wherein a circuit board, that includes the processor, electronic memory, receiver, and transmitter, is attached to the end cap such that the circuit board is disposed within the open portion when the end cap is assembled to the open portion.

15. The mobile gateway device of claim 1, wherein the housing includes one or more LED light portals that provide a status indicator for the mobile gateway device.

16. The mobile gateway device of claim 1, wherein the one or more LED light portals are color coded where different colored lights are used to indicate different operating modes of the mobile gateway device.
